(19) United States
(12) Patent Application Publication
(10) Pub. No.: US 2025/0111191 A1
(43) Pub. Date: Apr. 3, 2025

(54) NEURAL NETWORK MACHINE LEARNING MODEL

(71) Applicant: Schlumberger Technology Corporation, Sugar Land, TX (US)

(72) Inventor: John Godlewski, Menlo Park, CA (US)

(21) Appl. No.: 18/902,048

(22) Filed: Sep. 30, 2024

Related U.S. Application Data
(60) Provisional application No. 63/586,401, filed on Sep. 28, 2023.

(51) Int. Cl. G06N 3/04; E21B 47/00

(52) U.S. Cl. CPC G06N 3/04; E21B 47/00; E21B 2200/20; E21B 2200/22

(57) ABSTRACT

Certain aspects provide a method for assigning a plurality of physical properties in space and time of a target underground region to a plurality of structural nodes defined for a first layer of a graph neural network machine learning model; constructing a regular grid from the plurality of structural nodes; generating, by a neural operator layer of the graph neural network machine learning model and using a fast Fourier transform, a neural operator output; projecting, by the neural operator layer via an inverse fast Fourier transform, the neural operator output onto the regular grid to generate an inverse grid; and generating a prediction from a second layer of the graph neural network machine learning model.

### CROSS REFERENCE OF RELATED APPLICATION

This Application claims the benefit of and priority to U.S. Provisional Patent Application No. 63/586,401 filed on Sep. 28, 2023, the entire contents of which are herein incorporated by reference.

### BACKGROUND

Constructing subsurface wells may represent a capital investment, often costing in the order of millions to tens of millions of U.S. dollars. If constructed correctly, such wells allow the recovery of valuable hydrocarbons, such as oil and natural gas. Such wells also may be used to produce hot water for use in geothermal energy production, to store gases for later use, and to sequester carbon dioxide to mitigate climate change. However, when a new well is to be drilled in a field, a difficult problem arises with respect to determining where to place a new well. Even after the well is placed, subsurface conditions may inform a geologist as to how to operate the well.

In order to make decisions on where to place and how to operate a well, it is desirable to obtain accurate estimations of how fluids will flow in the subsurface. Predicted flow depends on a number of properties of the fluid. The properties may include fluid density and viscosity. The properties may include the conditions in the subface, such as pressure and temperature. The properties may include properties of the rock itself, such as permeability and porosity. These properties may change in both space a time. Often, a computer is used to solve complex flow equations that account for the above-described properties, as well as other properties.

The coefficients of the flow equations change in both space and time and include a set of non-linear partial derivative equations. Solving these equations may include using linearization techniques, large computing resources, substantial electricity, and time. The time, computing resources, and power used to solve such equations may be deemed undesirable. The time used by a computer to solve such equations may be particularly problematic, as in some cases decisions regarding where to drill or how to drill may be made in time periods less than the computing time taken to solve the equations.

### SUMMARY

Certain aspects provide a method for assigning a plurality of physical properties in space and time of a target underground region to a plurality of structural nodes defined for a first layer of a graph neural network machine learning model; constructing a regular grid from the plurality of structural nodes, wherein the regular grid is generated as an output of the first layer of the graph neural network machine learning model, wherein the first layer takes, as input, the plurality of structural nodes, and wherein the regular grid expands the plurality of physical properties into a latent space; generating, by a neural operator layer of the graph neural network machine learning model and using a fast Fourier transform, a neural operator output, wherein the neural operator layer takes, as input, the latent space of the plurality of physical properties; projecting, by the neural operator layer via an inverse fast Fourier transform, the neural operator output onto the regular grid to generate an inverse grid; and generating a prediction from a second layer of the graph neural network machine learning model, wherein the second layer takes the inverse grid as input.

Other aspects provide systems configured to perform the aforementioned method as well as those described herein; non-transitory computer-readable medium comprising instructions that, when executed by one or more processors of a computer system, cause the computing system to perform the aforementioned method as well as those described herein.

The summary provided herein introduces a selection of concepts that are further described below in the detailed description. This summary is not intended to identify key or essential features of the claimed subject matter, nor is the summary intended to be used as an aid in limiting the scope of the claimed subject matter.

### BRIEF DESCRIPTION OF DRAWINGS

FIG. 1A and FIG. 1B show a computing system, in accordance with one or more embodiments.

FIG. 2 shows a method, in accordance with one or more embodiments.

FIG. 3 shows an example of a method, in accordance with one or more embodiments.

FIG. 4 shows examples, in accordance with one or more embodiments.

FIGS. 5A-5B show a computing system and network environment, in accordance with one or more embodiments.

### DETAILED DESCRIPTION

In general, embodiments are directed to a technical solution to the technical problem that current computers use an undesirable amount of time to perform a computer simulation of subsurface flows. One or more embodiments present a technical solution by improving the architecture of a graph neural network machine learning model. Specifically, the architecture of the improved graph neural network permits faster, more efficient, and more accurate simulations of subsurface flows for flow simulations executed on a computer. Thus, one or more embodiments represent a technical solution to a technical problem in computer science.

In more particularity, one or more embodiments provide for an improved architecture for a graph neural network whereby a directed graph neural network is used to transform the subsurface flow problem from a structural (non-regular) grid to a regular grid. Then, one or more layers of the graph neural network may perform a Fourier neural operator, followed by a reverse operator from a directed graph neural network to a structural grid.

The developed architecture combines the structural flexibility of a graph approach with the superior performance of using the Fast Fourier Transform and spectral convolution of a Fourier neural operator. Thus, an improved graph neural network of one or more embodiments may be well suited to learn from the structurally complex, finite-volume numerical models used in computerized subsurface flow simulation.

Note that while a Fourier neural operator may be an efficient architecture for estimating such solutions, the performance of the Fourier neural operator uses the Fast Fourier Transform. However, the Fast Fourier Transform may be defined on regularly spaced grids. Such regular grids are rare in subsurface reservoir descriptions. Real reservoir subsurface structures are compressed, deformed, faulted and folded due to plate tectonics and forces in the Earth over millions of years. As such, subsurface properties change in an irregular fashion, which cannot be modeled in a regularly spaced grid. Thus, another improvement of one or more embodiments is to convert real, non-regular grids that model a real underground environment to a regular grid upon which the Fast Fourier Transform may be executed by a computer. Thus, again, speed of execution of the simulation increase dramatically, resulting in an improvement in the computer to generate a simulation result within a desirable amount of computing time.

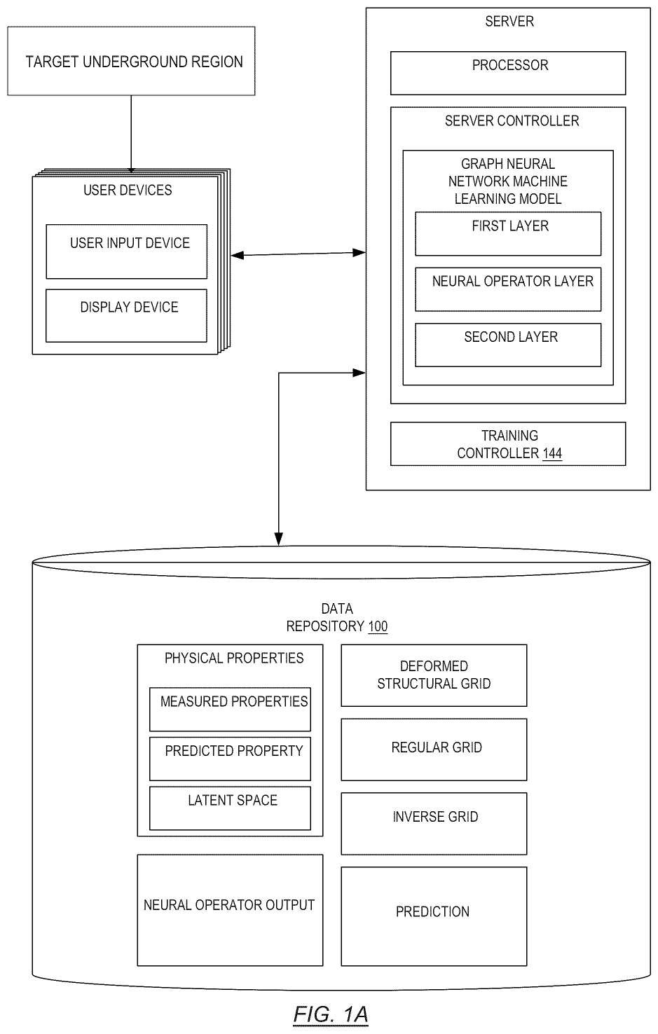

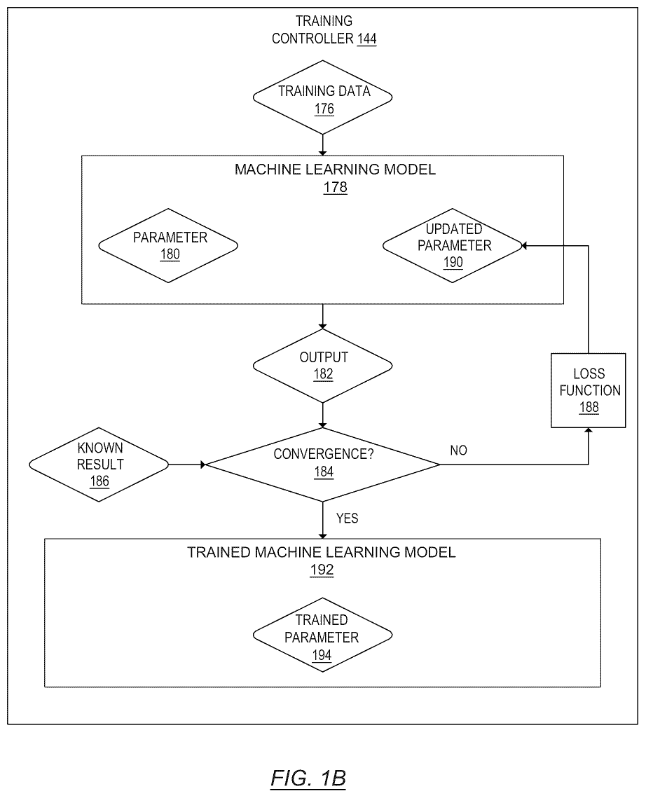

Attention is directed to FIG. 1A, which shows a computing system, in accordance with one or more embodiments. The system shown in FIG. 1A shows a data repository (100). In one or more embodiments, the data repository (100) may be a type of storage unit and/or device (e.g., a file system, database, data structure, or any other storage mechanism) for storing data. Further, the data repository (100) may include multiple different, potentially heterogeneous, storage units and/or devices.

The data repository (100) stores a variety of information used in one or more embodiments. The information is described or referenced elsewhere herein. The information includes physical properties. The physical properties include measured properties, a predicted property, and properties in the encoded/latent space. The data repository (100) also includes a neural operator output, a deformed structural grid, a regular grid, an inverse grid, and a prediction.

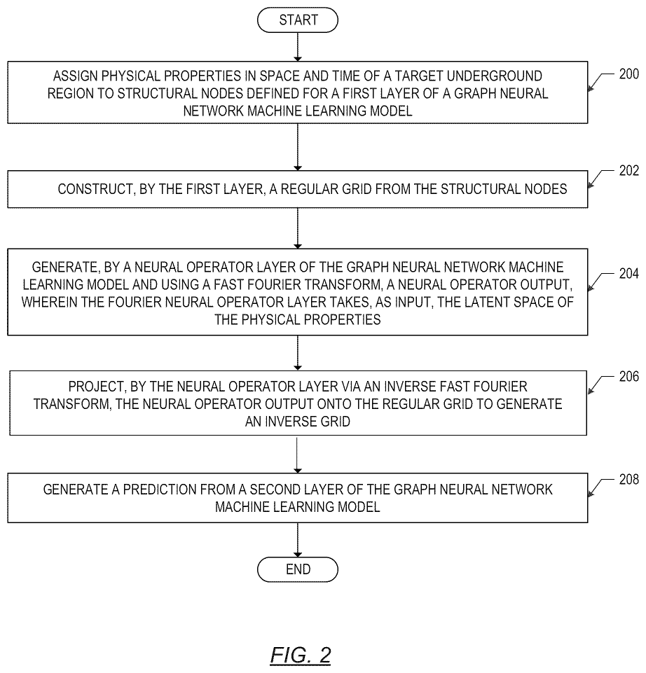

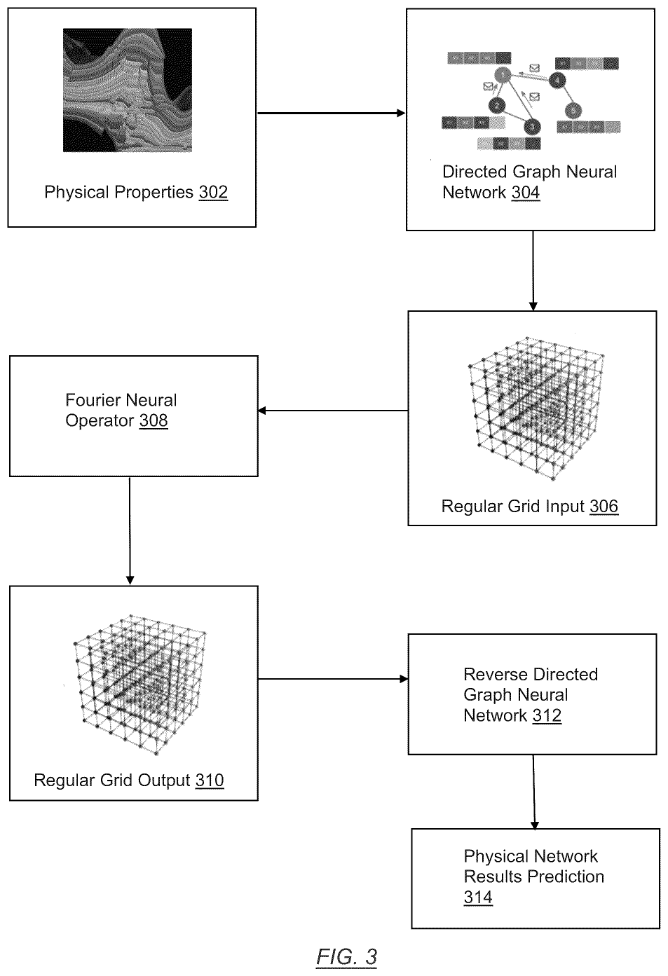

The system of FIG. 1A also includes a server having a processor, a server controller for executing a process (such as in FIG. 2 or FIG. 3), and a training controller (144) for training one or more machine learning models. The server controller includes a graph neural network machine learning model. The graph neural network machine learning model includes a first layer (see FIG. 2), a second layer (see FIG. 2), and a neural operator layer (see FIG. 2).

The system of FIG. 1A may include one or more user devices having user input devices and display devices. However, the user devices may be remote computers not part of the system of FIG. 1A. The system of FIG. 1A may refer to a target underground region, which is a physical subsurface region of the Earth.

Attention is turned to FIG. 1B, which shows the details of the training controller (144). The training controller (144) is a training algorithm, implemented as software or application specific hardware, that may be used to train one or more the machine learning models described with respect to FIG. 1A, including the graph neural network machine learning model.

In general, machine learning models are trained prior to being deployed. The process of training a model, briefly, involves iteratively testing a model against test data for which the final result is known, comparing the test results against the known result, and using the comparison to adjust the model. The process is repeated until the results do not improve more than some predetermined amount, or until some other termination condition occurs. After training, the final adjusted model (i.e., the trained machine learning model (192)) is applied to unknown data (i.e., data for which a prediction has not been previously made) in order to make predictions.

In more detail, training starts with training data (176). The training data (176) is data for which the final result is known with certainty. For example, if the machine learning task is to identify whether two names refer to the same entity, then the training data (176) may be name pairs for which it is already known whether any given name pair refers to the same entity.

The training data (176) is provided as input to the machine learning model (178). The machine learning model (178), as described before, is an algorithm. However, the output of the algorithm may be changed by changing one or more parameters of the algorithm, such as the parameter (180) of the machine learning model (178). The parameter (180) may be one or more weights, the application of a sigmoid function, a hyperparameter, or possibly many different variations that may be used to adjust the output of the function of the machine learning model (178).

One or more initial values are set for the parameter (180). The machine learning model (178) is then executed on the training data (176). The result is a output (182), which is a prediction, a classification, a value, or some other output which the machine learning model (178) has been programmed to output.

The output (182) is provided to a convergence process (184). The convergence process (184) compares the output (182) to a known result (186). A determination is made whether the output (182) matches the known result (186) to a pre-determined degree. The pre-determined degree may be an exact match, a match to within a pre-specified percentage, or some other metric for evaluating how closely the output (182) matches the known result (186). Convergence occurs when the known result (186) matches the output (182) to within the pre-determined degree.

If convergence has not occurred (a “no” at the convergence process (184)), then a loss function (188) is generated. The loss function (188) is a program which adjusts the parameter (180) in order to generate an updated parameter (190). The basis for performing the adjustment is defined by the program that makes up the loss function (188), but may be a scheme which attempts to guess how the parameter (180) may be changed so that the next execution of the machine learning model (178) using the training data (176) with the updated parameter (190) will have an output (182) that more closely matches the known result (186).

In any case, the loss function (188) is used to specify the updated parameter (190). As indicated, the machine learning model (178) is executed again on the training data (176), this time with the updated parameter (190). The process of execution of the machine learning model (178), execution of the convergence process (184), and the execution of the loss function (188) continues to iterate until convergence.

Upon convergence (a “yes” result at the convergence process (184)), the machine learning model (178) is deemed to be a trained machine learning model (192). The trained machine learning model (192) has a final parameter, represented by the trained parameter (194).

During deployment, the trained machine learning model (192) with the trained parameter (194) is executed again, but this time on the unknown data for which the final result is not known. The output of the trained machine learning model (192) is then treated as a prediction of the information of interest relative to the unknown data.

While FIG. 1A and FIG. 1B show a configuration of components, other configurations may be used without departing from the scope of one or more embodiments. For example, various components may be combined to create a single component. As another example, the functionality performed by a single component may be performed by two or more components.

Attention is turned to FIG. 2. FIG. 2 shows a method which may be performed using the system shown in FIG. 1A and/or FIG. 1B.

Block 200 includes assigning physical properties in space and time of a target underground region to structural nodes defined for a first layer of a graph neural network machine learning model.

Block 202 includes constructing, by the first layer, a regular grid from the structural nodes. The regular grid is generated as an output of the first layer of the graph neural network machine learning model. The first layer takes, as input, the plurality of structural nodes. The regular grid expands the physical properties into a latent space.

Block 204 includes generating, by a neural operator layer of the graph neural network machine learning model and using a fast Fourier transform, a neural operator output. The Fourier neural operator layer takes, as input, the latent space of the physical properties.

Block 206 includes projecting, by the neural operator layer via an inverse fast Fourier transform, the neural operator output onto the regular grid to generate an inverse grid.

Block 208 includes generating a prediction from a second layer of the graph neural network machine learning model. The second layer takes, as input the inverse grid.

The method of FIG. 2 may be stated more succinctly. Thus, one or more embodiments provide for a method including generating, from measured physical properties, a predicted physical property of a target underground region. Generating is performed by a graph neural network machine learning model which includes a neural operator layer. The neural operator layer performs a fast Fourier transform on a regular grid. The regular grid is derived from a deformed structural grid that contains the plurality of physical properties.

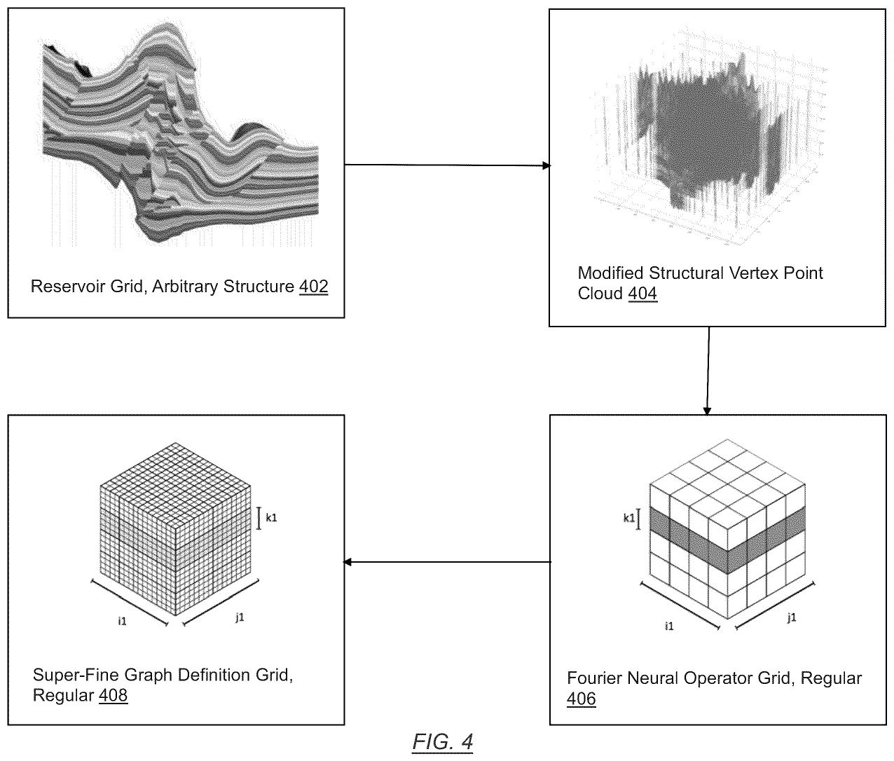

The method of FIG. 2 also is informed by the examples provided in FIG. 3 and FIG. 4. Thus, the details of FIG. 2 also may be inferred from the examples of FIG. 3 and FIG. 4.

While the various blocks in the flowchart of FIG. 2 are presented and described sequentially, at least some of the blocks may be executed in different orders, may be combined or omitted, and at least some of the blocks may be executed in parallel. Furthermore, the blocks may be performed actively or passively.

The following examples are for explanatory purposes and not intended to limit the scope of one or more embodiments. Attention is first turned to the example of FIG. 3.

As indicated above, one or more embodiments may include a neural architecture whereby a directed graph neural network is used to transform the problem from the structural (non-regular) grid to a regular grid, then perform a Fourier neural operator, and then a reverse-directed graph neural network to the structural grid. The developed architecture combines the structural flexibility of a graph approach with the superior performance of using the Fast Fourier Transform and spectral convolution of a Fourier neural operator. The developed architecture may be suited to learn from structurally complex finite-volume numerical models.

The workflow of FIG. 3 may involve 7 blocks as outlined below. However, some embodiments may use fewer blocks, additional blocks, or may include variations within a block.

Block 302: The physical properties of interest-porosity, permeability to flow in multiple directions, rock properties, depth, well locations and others are taken from a 3-D reservoir model with arbitrary geometry. The properties are each assigned to a structural node defined by its co-ordinates in space and time (x, y, z, t).

Block 304: A regular grid is constructed with nodes spaced at a constant interval in space and time. Connections (edges) are constructed between the two grids from the structural nodes to the regular nodes where their volumes overlap. A graph neural network passes message from the structural nodes to the regular nodes via small, fully connected neural networks, expanding the feature set into a latent space.

Block 306: Multiple messages from the nodes are aggregated to be the regular grid input.

Block 308: Fourier neural operators are used, involving four passes through the fast Fourier transform and convolution in the Fourier space.

Block 310: The output of the Fourier neural operators may be projected onto the regular grid via the inverse fast Fourier transform.

Block 312: The inverse directed graph neural network passes messages from the regular grid output, back to the structural grid nodes.

Block 314: The messages may be aggregated into a final prediction from the neural network-such as but not limited to pressure, fluid saturations, dissolved gas, chemical component quantities, precipitant quantities, stress, strain, deformation and fractures.

Attention is now turned to FIG. 4, which show additional details regarding what is shown and described with respect to FIG. 3.

One or more embodiments recognize that Fourier neural operators may estimate the solution to the partial differential equations used to model fluid flow in a target underground region. The Fourier neural operator is an efficient architecture for estimating such solutions. However, the performance of the Fourier neural operator may use the fast Fourier transform, which is defined on regularly spaced grids. Such regular grids are rare in subsurface reservoir descriptions. Reservoir are compressed, deformed, faulted and folded due to plate tectonics and forces in the earth over millions of years. As such, properties of structured (deformed) regions change in an irregular fashion.

Furthermore, the Fourier neural operator is most accurate when the partial differential equations are elliptic and the result is smooth. In reality, a natural reservoir has a large number of discontinuities and a major component of the flow equations are hyperbolic in nature. As such, substantial room for improved accuracy exists.

As indicated above, one or more embodiments describe a computing system that can estimate the solution to subsurface flow equations on an irregular grid several orders of magnitude faster. This allows a decision maker to explore a much larger quantity of scenarios and more fully consider the risk and uncertainty of their capital expenditure.

The architecture involves a graph neural network that encodes and translates the irregularly spaced input onto a regularly spaced latent grid before and after Fourier neural operators. This machine learning model architecture allows one to conserve the discontinuities of subsurface properties, match their description with arbitrary spacing, and improve the accuracy vs other systems.

Spatially, the reservoir defined in 4 different way in this computing system, as seen in FIG. 4.

In block 402, FIG. 4, an irregular grid is assumed to be of corner point definition. The properties on the corner grid may be physical 3-D subsurface properties. The properties may be the main input grid.

In block 404, FIG. 4 shows a point modified point cloud based on the input of block 402. The point cloud may be irregularly spaced.

In block 406, FIG. 4 shows a regular grid. The regular grid is at the resolution that the Fourier neural operators will be calculated.

In block 408, FIG. 4 shows a regular graph definition grid.

The grids and point clouds may have the same or similar minimum and maximum spatial extent defined by the grid in block 402. The point cloud in block 404 and the grid in block 408 may define the edge weights of the graph neural network which flows between the grid in block 402 and the grid in block 406.

The network architecture describes a graph encoder network. A graph neural network is used to pass information from the structured grid (block 402) to the regular grid (block 406). The graph input contains the physical properties on the (irregular) input nodes. The physical properties are passed through a multi-layer perceptron with ReLU non-linear activation functions from the input nodes (irregular grid) to the output nodes (regular grid), weighted by the relevant edge weights, like the below.

$${x}_{i}^{( k )} = \begin{matrix}⊕ & {ϕ}^{( k )} & ( {x}_{j}^{( k - 1 )} , {e}_{j , i} )\end{matrix} \qquad ( equation 1 )$$

Where xᵢ^{(k)} are the embedded output properties in the latent space on the regular grid (FIG. 4.3). The terms xⱼ^{(k-1)} are the physical properties on the nodes on the irregular grid. The symbol “ϕ^{(k)}” is a multilayer perceptron that expands from the input to dimension to the output dimension. The symbol “⊕” denotes a differentiable, permutation invariant function (e.g., sum, mean, etc.). Non-standard aggregations may be used to match the underlying physics including combinations of sum, arithmetic mean, and harmonic means.

Self-loop and multiple passes may be added. The graph may be directed-flowing from the source nodes (on the grid scale in block 402) to the target nodes (on the grid scale in block 406).

The input features of the graph are the physical properties that are present at the cell location, such as the permeability in each direction (x, y, z), the porosity, depth, relative permeability end-points, relative permeability curvatures, mechanical rock properties and the control settings of a well if the well is present in that cell.

The graph neural network spatially may combine data that is physically proximate. The graph neural network may convert data structure from an irregular grid to a regular grid. The graph neural network may encode the physical information in the grid shown in block 402 into a latent space. The graph neural network lifts the information to a higher dimension, like multi-parameter regression.

Attention is turned to the topic of graph neural network edge weight definition. The base case may assume that subsurface properties are available on a non-regular grid as defined by corner-point geometry. Corner point geometry uses a series of lines and vertices to create a 3D mesh. Modification of the below can be made for other grid types.

The irregular grid of block 402 may be converted into a point cloud to assist in creating the edges for the graph neural network. The point cloud may be created by taking the cell corners that define each cell of the 3-D mesh (corner-point vertices) and taking the weighted average of their (x, y, z) locations and the location of the corresponding cell center. The equation may be weighted heavily on the vertex location and lightly on the cell center location. The result of the weighted equation output is a point cloud (block 404) where each vertex is unique to each cell, shifted slightly from a starting point.

Two regular grids may then be created. The first grid is the Fast Fourier Transform (FFT) grid (block 406). The first grid may have the same total extent as the irregular grid-that is, the same minimum and maximum in x, y, z as the irregular grid. The FFT grid may be the grid on which the Fourier neural operators will be calculated, so the resolution of the FFT grid may be chosen such that the whole neural network fits into the available RAM (random access memory) of the computer with acceptable performance. The FFT grid may have a higher resolution than the irregular grid.

The regular grid may have different numbers of rows, columns, or layers, and instead can be an arbitrary rectangle. The regular grid also may be aligned with x, y and z and can instead be arbitrarily slanted.

The second regular grid may be the graph definition grid (block 408). The second regular grid may be the same as the FFT but at higher resolution to help define the edge weights of the graph neural network. In each direction, the total number of cells in this grid may be an integer multiplied by the FFT dimension. That is, each sub-cell in the graph definition grid may be contained inside of its parent cell in the FFT grid. One use of the graph-definition grid is to provide a high-resolution mapping between the grids. If the integer 10 is chosen in each direction, this process may create cells that are 1000× smaller than that FFT grid. Different integers can be chosen for each direction to best match the heterogeneity of the physical properties.

A KD-tree search may be completed between the cell centers of the graph definition grid (block 408) and the modified point cloud (block 404) to find each set of nearest neighbors. The resulting nearest neighbors may be grouped by each FFT parent cell to which the graph definition cell is a part.

A graph edge connection may be formed in the graph neural network between the irregular cell and the FFT cells where any nearest neighbor found above exists. The number of such neighbors may be the edge weight in the graph network. Cell pairs with a count of zero have no connection created. Cells where the irregular grid cell has zero or inactive properties are also excluded.

Attention is now turned to the Fourier neural operator. Once the output features from the GNN are defined on the grid shown in block 406, Fourier neural operators architecture is used, according the operations below.

First, the Fast Fourier Transform may be performed on the encoded points in serially in 4 dimensions-3 spatial dimensions (x, y, z) and time. Second, truncate higher frequencies than 12 modes for the spatial domain, and 8 for the time domains. Third, convolutions with (learned) weights in the Fourier space may be performed. These convolutions may be matrix multiplications. Fourth, the inverse Fast Fourier Transform on the results of operation 3 may be performed. Fifth, locally, each point from operation 2 may go through a one dimensional convolution. Sixth, the results from operation 5 and operation 6 may be combined into a non-linear activation function plus bias term.

A seventh operation may be included. The seventh operation may use the output of operation 6 as the new encoded output, in which case operations 3 to 7 are repeated. The seventh operation may be repeated multiple times, and may be iterated three, four, or more times.

The output of the Fourier neural operator are a set of latent result properties on the regular FFT grid (block 406). The output is provided to a graph decoder network.

Attention is turned to the graph decoder network. An inverse or ‘decoding’ graph neural network is used to transform this output the final predicted result on the irregular graph scale. The edge weights may be the same as the encoding graph neural network, but with the directionality reversed.

The output of the decoder network is one or more predictions of the physical conditions of interest, such as the pressure, fluid types, chemical concentrations, stress, strain and deformation at each point at some time in the future. This output can be compared to the results of a physics simulation on the irregular grid. The difference between the two (i.e., the results of the comparison) can be used in back-propagation to improve the network in a training operation. (See FIG. 1B for training).

Thus, one or more embodiments may provide for a type of neural network architecture that combines the flexibility of graph neural networks with the high performance of Fourier neural operators. One or more embodiments may vastly improve (i.e., by a factor of ten or more) the efficiency of a computer when applying machine learning techniques to realistic subsurface reservoirs.

Note that the construction of the connections in the graph neural network and the application to a subsurface system of one or more embodiments are a difference between the techniques described herein and prior attempts to solve the technical problem described herein. For example, prior attempts make simple graph connections from the nodes within a given radius. This approach imposes a pre-set type of resolution to the grid that is not flexible and does not match the high heterogeneity seen in natural subsurface reservoirs. Such systems are characterized by a large number of sharp discontinuities. Small, thin shale layers are common and block flow completely across them. Similarly, faults are nearly ubiquitous, and create a sharp, step change in the properties on either side of their surfaces. When graph connections are made in the manner provided herein, the location and fidelity of the sharp changes are preserved. Thus, one or more embodiments are not just faster, but also more accurate than other approaches for addressing the technical problem described herein.

The method of aggregation in the graph neural network of one or more embodiments is also useful. Prior techniques may use a weighted sum. In contrast, one or more embodiments use a combination of sum, arithmetic, and harmonic averages to create properties in the latent space, as those aggregations match the properties of the underlying reservoir physics. Thus, again, one or more embodiments are both more accurate and faster than other techniques.

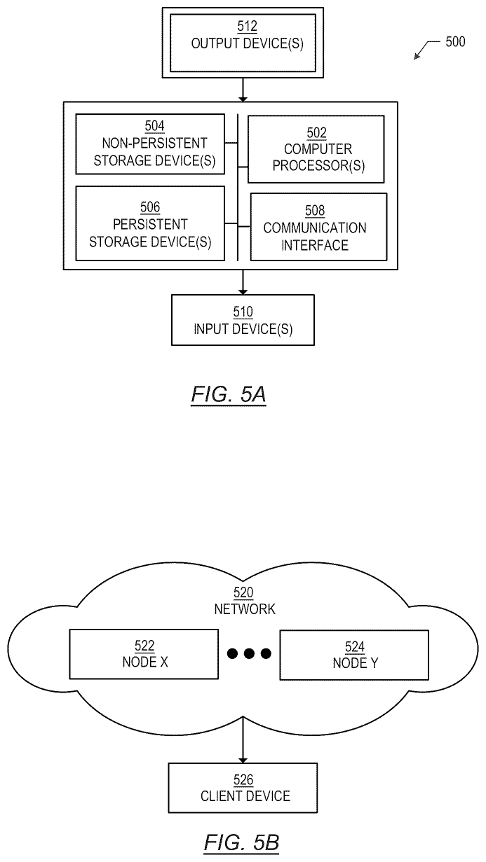

Embodiments may be implemented on a computing system specifically designed to achieve an improved technological result. When implemented in a computing system, the features and elements of the disclosure provide a technological advancement over computing systems that do not implement the features and elements of the disclosure. Any combination of mobile, desktop, server, router, switch, embedded device, or other types of hardware may be improved by including the features and elements described in the disclosure. For example, as shown in FIG. 5A, the computing system (500) may include one or more computer processors (502), non-persistent storage (504), persistent storage (506), a communication interface (508) (e.g., Bluetooth interface, infrared interface, network interface, optical interface, etc.), and numerous other elements and functionalities that implement the features and elements of the disclosure. The computer processor(s) (502) may be an integrated circuit for processing instructions. The computer processor(s) may be one or more cores or micro-cores of a processor. The computer processor(s) (502) includes one or more processors. The one or more processors may include a central processing unit (CPU), a graphics processing unit (GPU), a tensor processing units (TPU), combinations thereof, etc.

The input devices (510) may include a touchscreen, keyboard, mouse, microphone, touchpad, electronic pen, or any other type of input device. The input devices (510) may receive inputs from a user that are responsive to data and messages presented by the output devices (512).

The inputs may include text input, audio input, video input, etc., which may be processed and transmitted by the computing system (500) in accordance with the disclosure. The communication interface (508) may include an integrated circuit for connecting the computing system (500) to a network (not shown) (e.g., a local area network (LAN), a wide area network (WAN) such as the Internet, mobile network, or any other type of network) and/or to another device, such as another computing device.

Further, the output devices (512) may include a display device, a printer, external storage, or any other output device. One or more of the output devices may be the same or different from the input device(s). The input and output device(s) may be locally or remotely connected to the computer processor(s) (502). Many different types of computing systems exist, and the aforementioned input and output device(s) may take other forms. The output devices (512) may display data and messages that are transmitted and received by the computing system (500). The data and messages may include text, audio, video, etc., and include the data and messages described above in the other figures of the disclosure.

Software instructions in the form of computer readable program code to perform embodiments may be stored, in whole or in part, temporarily or permanently, on a non-transitory computer readable medium such as a CD, DVD, storage device, a diskette, a tape, flash memory, physical memory, or any other computer readable storage medium. Specifically, the software instructions may correspond to computer readable program code that, when executed by a processor(s), is configured to perform one or more embodiments, which may include transmitting, receiving, presenting, and displaying data and messages described in the other figures of the disclosure.

The computing system (500) in FIG. 5A may be connected to or be a part of a network. For example, as shown in FIG. 5B, the network (520) may include multiple nodes (e.g., node X (522), node Y (524)). Each node may correspond to a computing system, such as the computing system shown in FIG. 5A, or a group of nodes combined may correspond to the computing system shown in FIG. 5A. By way of an example, embodiments may be implemented on a node of a distributed system that is connected to other nodes. By way of another example, embodiments may be implemented on a distributed computing system having multiple nodes, where each portion may be located on a different node within the distributed computing system. Further, one or more elements of the aforementioned computing system (500) may be located at a remote location and connected to the other elements over a network.

The nodes (e.g., node X (522), node Y (524)) in the network (520) may be configured to provide services for a client device (526), including receiving requests and transmitting responses to the client device (526). For example, the nodes may be part of a cloud computing system. The client device (526) may be a computing system, such as the computing system shown in FIG. 5A. Further, the client device (526) may include and/or perform at least a portion of one or more embodiments.

The computing system of FIG. 5A may include functionality to present raw and/or processed data, such as results of comparisons and other processing. For example, presenting data may be accomplished through various presenting methods. Specifically, data may be presented by being displayed in a user interface, transmitted to a different computing system, and stored. The user interface may include a GUI that displays information on a display device. The GUI may include various GUI widgets that organize what data is shown as well as how data is presented to a user. Furthermore, the GUI may present data directly to the user, e.g., data presented as actual data values through text, or rendered by the computing device into a visual representation of the data, such as through visualizing a data model.

As used herein, the term “connected to” contemplates multiple meanings. A connection may be direct or indirect (e.g., through another component or network). A connection may be wired or wireless. A connection may be temporary, permanent, or semi-permanent communication channel between two entities.

The various descriptions of the figures may be combined and may include or be included within the features described in the other figures of the application. The various elements, systems, components, and blocks shown in the figures may be omitted, repeated, combined, and/or altered as shown from the figures. Accordingly, the scope of the present disclosure should not be considered limited to the specific arrangements shown in the figures.

In the application, ordinal numbers (e.g., first, second, third, etc.) may be used as an adjective for an element (i.e., any noun in the application). The use of ordinal numbers is not to imply or create any particular ordering of the elements nor to limit any element to being a single element unless expressly disclosed, such as by the use of the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

Further, unless expressly stated otherwise, or is an “inclusive or” and, as such includes “and.” Further, items joined by an or may include any combination of the items with any number of each item unless expressly stated otherwise.

In the above description, numerous specific details are set forth in order to provide a more thorough understanding of the disclosure. However, it will be apparent to one of ordinary skill in the art that the technology may be practiced without these specific details. In other instances, well-known features have not been described in detail to avoid unnecessarily complicating the description. Further, other embodiments not explicitly described above can be devised which do not depart from the scope of the claims as disclosed herein. Accordingly, the scope should be limited by the attached claims.

What is claimed is:

1. A method comprising:
assigning a plurality of physical properties in space and time of a target underground region to a plurality of structural nodes defined for a first layer of a graph neural network machine learning model;
constructing a regular grid from the plurality of structural nodes;
generating, by a neural operator layer of the graph neural network machine learning model and using a fast Fourier transform, a neural operator output;
projecting, by the neural operator layer via an inverse fast Fourier transform, the neural operator output onto the regular grid to generate an inverse grid; and
generating a prediction from a second layer of the graph neural network machine learning model.

2. The method of claim 1, wherein the regular grid is generated as an output of the first layer of the graph neural network machine learning model.

3. The method of claim 2, wherein the first layer takes, as input, the plurality of structural nodes.

4. The method of claim 3, wherein the regular grid expands the plurality of physical properties into a latent space.

5. The method of claim 1, wherein the neural operator layer takes, as input, the latent space of the plurality of physical properties.

6. The method of claim 1, wherein the second layer takes the inverse grid as input.

7. The method of claim 1, wherein the plurality of physical properties is from a 3D reservoir model with arbitrary geometry and includes porosity, permeability to flow in multiple directions, rock properties, depth, and well locations.

8. A system comprising:
a memory comprising computer-executable instructions; and
a processor configured to execute the computer-executable instructions and cause the system to:
assign a plurality of physical properties in space and time of a target underground region to a plurality of structural nodes defined for a first layer of a graph neural network machine learning model;
construct a regular grid from the plurality of structural nodes;
generate, by a neural operator layer of the graph neural network machine learning model and using a fast Fourier transform, a neural operator output;
project, by the neural operator layer via an inverse fast Fourier transform, the neural operator output onto the regular grid to generate an inverse grid; and
generate a prediction from a second layer of the graph neural network machine learning model.

9. The system of claim 8, wherein the regular grid is generated as an output of the first layer of the graph neural network machine learning model.

10. The system of claim 9, wherein the first layer takes, as input, the plurality of structural nodes.

11. The system of claim 10, wherein the regular grid expands the plurality of physical properties into a latent space.

12. The system of claim 8, wherein the neural operator layer takes, as input, the latent space of the plurality of physical properties.

13. The system of claim 8, wherein the second layer takes the inverse grid as input.

14. The system of claim 8, wherein the plurality of physical properties is from a 3D reservoir model with arbitrary geometry and includes porosity, permeability to flow in multiple directions, rock properties, depth, and well locations.

15. A non-transitory computer-readable medium comprising instructions that, when executed by one or more processors of a computer system, cause the computing system to perform operations, the operations comprising:
assigning a plurality of physical properties in space and time of a target underground region to a plurality of structural nodes defined for a first layer of a graph neural network machine learning model;
constructing a regular grid from the plurality of structural nodes;
generating, by a neural operator layer of the graph neural network machine learning model and using a fast Fourier transform, a neural operator output;
projecting, by the neural operator layer via an inverse fast Fourier transform, the neural operator output onto the regular grid to generate an inverse grid; and
generating a prediction from a second layer of the graph neural network machine learning model.

16. The non-transitory computer-readable medium of claim 15, wherein the regular grid is generated as an output of the first layer of the graph neural network machine learning model.

17. The non-transitory computer-readable medium of claim 16, wherein the first layer takes, as input, the plurality of structural nodes.

18. The non-transitory computer-readable medium of claim 17, wherein the regular grid expands the plurality of physical properties into a latent space.

19. The non-transitory computer-readable medium of claim 15, wherein the neural operator layer takes, as input, the latent space of the plurality of physical properties.

20. The non-transitory computer-readable medium of claim 15, wherein the second layer takes the inverse grid as input.
